(19) United States
(12) Patent Application Publication
(10) Pub. No.: US 2004/0078625 A1
(43) Pub. Date: Apr. 22, 2004

(54) System and method for fault tolerant data communication

(75) Inventors: Ashoke Rampuria, Acton, MA (US); Pradip Dhara, Somerville, MA (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Avici Systems, Inc., N. Billerica, MA

(21) Appl. No.: 10/350,306

(22) Filed: Jan. 22, 2003

Related U.S. Application Data
(60) Provisional application No. 60/351,717, filed on Jan. 24, 2002.

(51) Int. Cl. G06F 11/00

(52) U.S. Cl. 714/4

(57) ABSTRACT

A system and method for fault tolerant data communication. Embodiments of the invention may be applied to a variety of applications, including routers that exchange routing table updates within a network environment. A primary process engages in a communication with a remote process, which includes the transfer of content and communication state. The primary process stores the content and communication state into a data store. In the event the primary process fails, the communication with the remote process is transferred to a backup process which mirrors the primary process by retrieving the content and the communication state from the data store. The backup process, thus, continues the communication with the remote process using the communication state retrieved from the data store.

### RELATED APPLICATION

This application claims the benefit of U.S. Provisional Application No. 60/351,717, filed on Jan. 24, 2002. The entire teachings of the above application are incorporated herein by reference.

### BACKGROUND OF THE INVENTION

The Internet is a global internetwork of individual computer networks interconnected by links, such as SONET (Synchronous Optical NETwork) and Gigabit Ethernet (GigE). As illustrated in FIG. 1, routers 10 terminate the ends of links 15, providing a multiplexed interface for forwarding incoming network packets toward their final destinations.

Data is communicated over such internetworks through formatted transmission units, commonly referred to as packets. The format of a packet is defined by a suite of network transmission protocols, such as TCP/IP (Transmission Control Protocol/Internet Protocol). For example, a TCP/IP packet includes an IP header and a TCP segment. The IP header identifies the IP addresses of the source and destination hosts, which are used by routers 10 to direct the TCP/IP packet over links 15 towards the destination host. The TCP segment further includes a TCP header and application data that is being transported to the final destination. The TCP header identifies the endpoints of a TCP connection by specifying internal port addresses associated with applications executing on the source and destination hosts. Furthermore, since TCP is a connection-oriented protocol, the TCP header also includes sequence numbers for identifying and acknowledging TCP segments.

To perform packet routing, routers 10 maintain internal routing tables 12, which are data structures for computing the “next hop” associated with a network identifier. A “next hop” typically leads to an intermediate router, providing a gateway toward one or more destination networks. Routers 10 reference their routing tables 12 when attempting to forward packets over appropriate links 15. A packet generally includes a packet header and a data payload. Routers 10 utilize the packet destination extracted from the packet header to index into its routing table 12 for the next hop address. Once a next hop is identified, the router 10 forwards the packet over the appropriate link 15 to the next hop address along the path towards its final destination.

With Internet routing, for example, each entry in a routing table has at least two field values, an IP Address Prefix 14a and a Next Hop 14b. The Next Hop 14b is the IP address of another host or router that is directly reachable via an Ethernet, serial link, or some other physical connection. The IP Address Prefix 14a is the network identifier, which specifies a set of destinations for which the routing entry is valid. In order to be in this set, the beginning of the destination IP address must match the IP Address Prefix 14a, which can have from 0 to 32 significant bits. For example, any IP Destination Address of the form 128.8.x.x would match an IP Address Prefix 14a, of 128.8.0.0/16.

Routers 10 dynamically “learn” and update routing table entries by exchanging routing table updates with each other over network connections. Internet routers typically exchange routing table updates over TCP/IP connections. Through such exchanges, a router 10 receiving an update may dynamically incorporate the modifications into its internal routing table 12 and send the update to further routers within the internetwork 1.

For example, referring to FIG. 1, assume router 10b connects a new network 30 to the internetwork 1. Router 10b may, in turn, establish a network connection with router 10a to exchange routing tables. The routing table update from router 10b would identify router 10b as the “next hop” for network 30. Router 10a may then establish network connections with each of the other routers 10c, 10d in order to update their routing tables 12, adding network 30 as an entry. After incorporating the update into their routing tables 12, the routers 10 may forward packets to the newly added destination network 30.

Internet routers implement server processes for handling the routing operations, including exchanges of routing table updates. Some Internet routers, such as the Avici TSR® family of routers, implement backup server processes to assume the routing operations in the event the primary server process fails.

### SUMMARY OF THE INVENTION

For proper packet routing, routing table updates must be exchanged reliably among the routers within an internetwork. Backup server processes are implemented to make a router highly available in the event a primary server process fails. Some routers implementing backup server processes periodically replicate their routing tables to persistent storage. Thus, if the primary server process fails, the backup server process may assume the routing operations with an internal routing table that is regenerated from the stored entries of the routing table.

However, if the primary server process fails during an exchange of a routing table update, the update is not secured in the persistent storage and is not available to the backup server process via the stored entries of the routing table. Even worse, the remote router involved in the failed exchange may deem the failed router unavailable and remove such entries from its internal routing table, even though the failed router may be transitioning from the primary server process to the backup server process. As a result, the router is effectively removed from the system until a reinitialization process is performed.

Embodiments of the invention provide a system and method for fault tolerant data communication, which allow a backup process to continue communicating with a remote process over a network connection that was previously established by a primary process. Such embodiments maintain the continuity of in-progress communications, preventing communication and data loss.

Embodiments of the invention provide a primary process engaged in a communication with a remote process, transferring content and communication state. The primary process stores the content and communication state in a data store, which is accessible to a backup process in the event of the primary fails. In the event of such failure, the communication with the remote process is transferred to a backup process which mirrors the primary process by retrieving the content and the communication state from the data store. The backup process may, thus, continue communicating with the remote process using the communication state retrieved from the data store.

The communication state includes the state of a network connection through which the update is communicated, such as a TCP connection. For TCP connections, the primary process further includes a fault tolerant, connection-oriented transport protocol that supports communications with remote processes implementing Transmission Control Protocol (TCP). According to one embodiment of the invention, the fault tolerant transport protocol is a modified version of TCP that stores the communication state to a data store, which is available to a backup process to continue communications over preestablished network connections.

Embodiments of the invention may be applied to a variety of applications, including routers exchanging routing table updates within a network environment. Such routers include a primary routing process coupled to one or more external links. The primary routing process may engage in a communication with a remote router via one of the external links, transferring routing data and communication state. The primary routing process stores the routing data and communication state in a data store, which is accessible to a backup routing process in the event the primary fails. According to one embodiment, the communication state is the state of a network connection through which the update is communicated.

In the event of such failure, the communication with the remote router is transferred to the backup routing process, which mirrors the primary routing process by retrieving the routing data and the communication state from the data store. Thus, the backup routing process may continue communicating with the remote router using the communication state retrieved from the data store.

According to one embodiment, the primary routing process may implement an Internet routing protocol, such as BGP (Border Gateway Protocol), which typically exchanges routing table updates over TCP (Transmission Control Protocol) connections. In such embodiments, the communication state is the current state of the TCP connection, including TCP port addresses, TCP state identifiers (e.g., CLOSED, LISTEN, ESTABLISHED, etc.), send and receive sequence numbers, acknowledged sequence numbers, etc.

The primary routing process stores a stored state in the data store, which is derived the communication state. For example, when a TCP segment is received having a send sequence number (i.e., communication state), a TCP receive sequence number (i.e., stored state) is derived from the send sequence number and stored in the data store for that connection. For some TCP connection states, the communication state is the same as the stored state.

TCP, however, does not guarantee application-to-application delivery of TCP segments. Instead, TCP transmits acknowledgments, commonly referred to as ACKs, in response to receiving a TCP segment. A TCP acknowledgment does not guarantee that the data has been delivered to the end user process, but only that the receiving TCP process has taken the responsibility to do so. Thus, with standard TCP, there is no guarantee that a routing table update has been processed and backed up by the primary server process when a TCP acknowledgment is received.

Embodiments of the invention further provide a system and method for providing application-to-application delivery of data by ensuring that content and communication state is replicated to the data store, prior to acknowledging receipt from a sending end of a communication (i.e., reading) or transmitting data to a receiving end of a communication (i.e., writing). Thus, when the backup process is initiated, loss of data is avoided during a transition from the primary process to the backup process.

Such embodiments are transparent to surrounding routers that may not implement embodiments of fault tolerant data communication (e.g., routers implementing standard TCP). Thus, no modifications are required to existing routers in order to interoperate with routers implementing embodiments of fault tolerant data communication.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a diagram illustrating routers interconnecting computer networks through links.

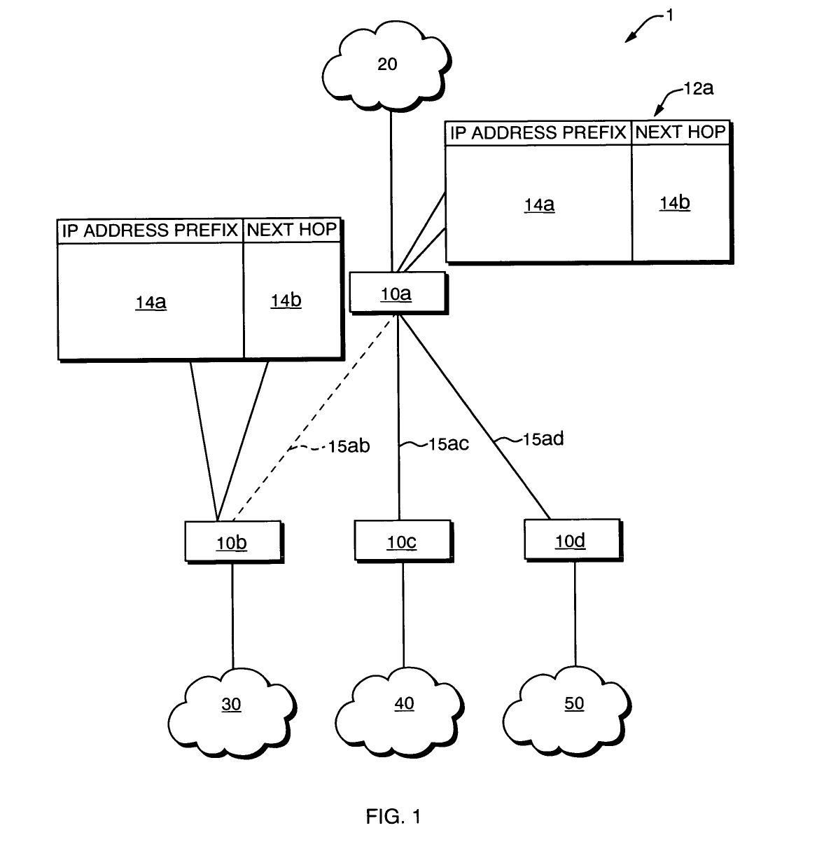

FIG. 2 is a diagram illustrating the hardware components of a switch router implementing fault tolerant data communication according to one embodiment.

FIG. 3A is a high level diagram illustrating fault tolerant data communication for a router during normal operation according to one embodiment.

FIG. 3B is a high level diagram illustrating fault tolerant data communication for a router during backup mode according to one embodiment.

FIG. 4 is a diagram illustrating the software components that implement fault tolerant TCP connections with remote peers according to one embodiment.

FIG. 5A is a state diagram illustrating read processing over a fault tolerant TCP connection according to one embodiment.

FIG. 5B is a state diagram illustrating write processing over a fault tolerant TCP connection according to one embodiment.

FIG. 6 is a flow diagram illustrating a process for re-establishing the FTTCP connections during backup mode of data communication from a primary application process to a backup application process according to one embodiment.

### DETAILED DESCRIPTION OF THE INVENTION

A description of preferred embodiments of the invention follows.

Embodiments of the invention provide a system and method for fault tolerant data communication. According to one embodiment, a fault tolerant transport layer protocol is implemented for establishing network connections with remote peers on behalf of an application process and for maintaining the current state of the connections in a repository. In the event the application process fails, the local side of the network connections may be regenerated from the stored states in the repository. Thus, a backup application process may continue communicating over those network connections without having to reestablish or reset the connections. Embodiments of the invention may be applied to a variety of applications in order to improve the reliability of data exchanges. According to one embodiment, routers, such as Internet routers, may implement fault tolerant data communication for exchanging routing table updates.

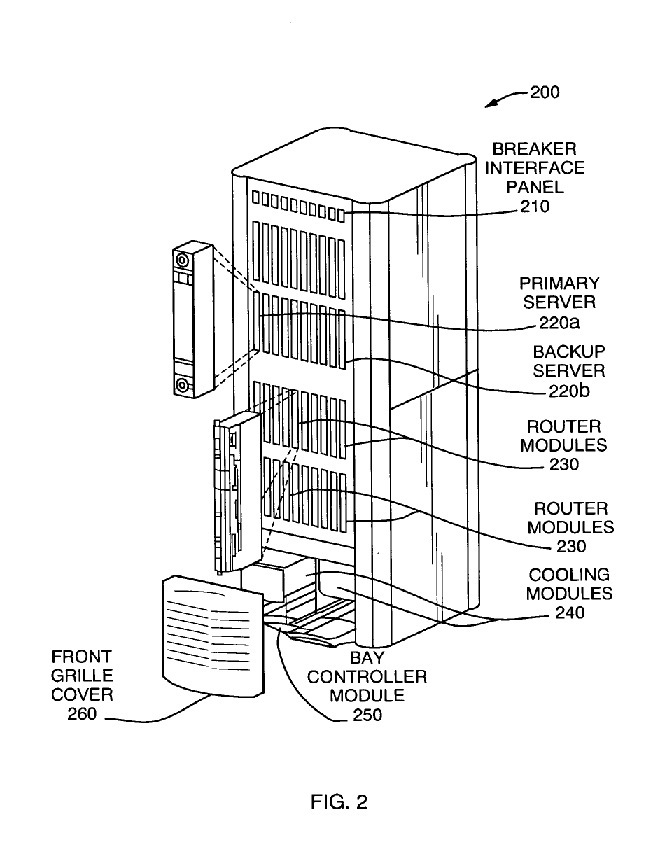

FIG. 2 is a diagram illustrating the hardware components of a switch router implementing fault tolerant data communication according to one embodiment. The switch router 200 may be an Internet router that forwards TCP/IP packets over external links toward their final destinations. The switch router 200 includes a number of router modules 230 managed by a primary server module 220a. A backup server module 220b is incorporated in the switch router 200 for managing the routing operations in case the primary server module 220a fails.

The primary server module 220a conducts the routing operations for the entire system 200. In particular, the primary server module 220a maintains routing tables for a number of IP routing protocols, including BGP (Border Gateway Protocol). BGP is described in more detail in “A Border Gateway Protocol 4 (BGP-4),” RFC 1771, Y. Rekhter and T. Li, March 1995, the entire contents of which are incorporated herein by reference. The routing tables are dynamically updated by the primary server module 220a by exchanging routing table updates with upstream and downstream routers coupled to the switch router 200 via external links.

Each router module 230 is coupled to an external link that terminates at a remote router, such as an Internet router. The router modules 230 are also coupled to each other creating an internal switch topology within the router 200, referred to as a fabric. However, other router configurations, such as those based on crossbar switches and buses, may be applied in order to interconnect the router modules 230. According to one embodiment, the fabric prevents internal deadlock and tree saturation by interconnecting the router modules 230 such that multiple paths are provided through the fabric from any source to any destination. According to one embodiment, each router module 230 includes an integrated switch and line card for routing packets internally within the fabric and externally from the fabric to remote routers.

Such fabrics include multi-dimensional toroidal fabrics and gamma graph fabrics. Multi-dimensional toroidal fabrics are discussed in more detail in U.S. Pat. No. 6,285,679 issued on Sep. 4, 2001, entitled “Methods and Apparatus for Event-Driven Routing,” the entire contents of which are incorporated herein by reference.

The primary and backup server modules 220a, 220b access the fabric through different router modules 230, referred to as server attached modules or SAMs. With access to the fabric via the SAM, the active server module may send and receive routing table updates over the external links.

The primary server module 220a is coupled to the backup server module 220b, providing a conduit for transferring data and control messages. According to one embodiment, the primary server module 220a is indirectly coupled to the backup server module 220b via an Ethernet repeater of the bay controller module 250 as well as directly coupled to the backup server module 220b via cross-over cabling.

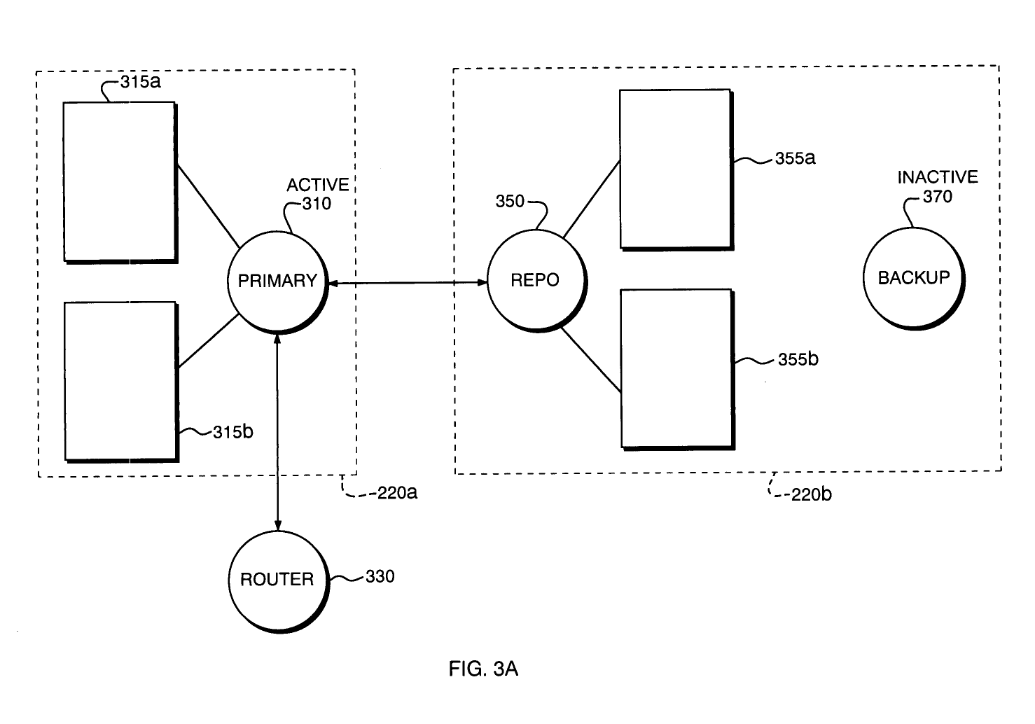

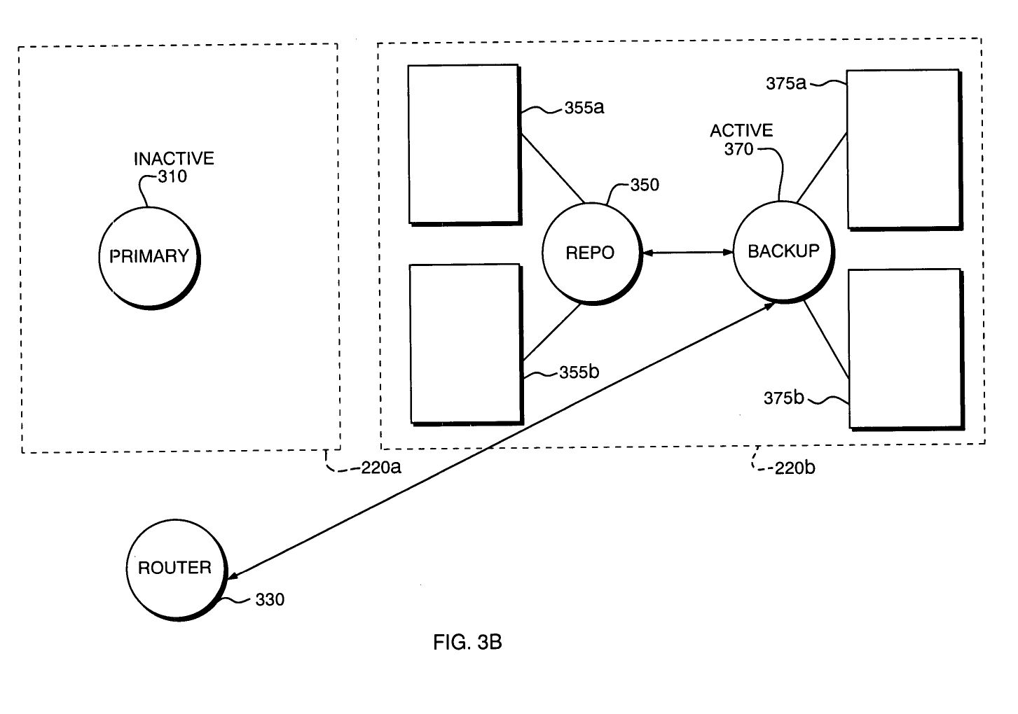

FIG. 3A is a high level diagram illustrating fault tolerant data communication for a router during normal operation according to one embodiment. During normal operation, the primary server process 310, executing within the primary server module 220a, initiates or accepts network connections with remote routers 330 in order to exchange routing table updates. If a routing table update changes the state of the routing table 315a (i.e., adds, deletes, or modifies a table entry), the primary server process 310 transmits the routing state change for storage to a repository 350 in the backup server module 220b. Thus, when the primary server process 310 fails, a backup server process 370, which is inactive during normal operation, may be generated with a routing table from the stored routing state 355a associated with the routing table 315a.

In addition to replicating routing table state changes, the primary server process 310 also replicates the connection states 315b of established network connections with remote routers 330. Thus, if the primary server process 310 fails (i) during an exchange of a routing table update or (ii) after a routing table update is exchanged but before being committed to the repository 350, the local side of the network connections may be regenerated from the stored connection state 355b in the repository 350. Thus, a backup server process 370 may proceed with exchanges currently in progress over previously established network connections from the point the primary server process 310 failed.

FIG. 3B is a high level diagram illustrating fault tolerant data communication for a router during backup mode according to one embodiment. When the primary server process 310 fails, control of the routing operations are transferred to a backup server process 370, which is instantiated on the backup server module 220b. The backup server process 370 generates a routing table 375a from the stored routing state 355a retrieved from the repository 350. Furthermore, the local side of network connections previously established with the primary server process 310 is regenerated from the stored connection states 355b in the repository 350, allowing the backup server process 370 to continue with exchanges of routing table updates currently in progress with remote routers 330. Such embodiments prevent routing table updates from being lost during a fail-over transition from the primary server process 310 to the backup server process 370.

With respect to Internet routers, BGP is an IFP routing protocol that exchanges routing table updates over TCP (Transport Control Protocol). TCP is a connection-oriented transport layer protocol, which is described in more detail in “RFC 793—Transmission Control Protocol,” Defense Advanced Research Projects Agency, 1981, the entire contents of which are incorporate herein by reference. TCP does not guarantee application-to-application delivery of TCP segments. Instead, TCP transmits acknowledgments, commonly referred to as ACKs, in response to receiving a TCP segment. A TCP acknowledgment does not guarantee that the data has been delivered to the end user process, but only that the receiving TCP process has taken the responsibility to do so. Thus, with standard TCP, there is no guarantee that a routing table update has been processed and backed up when a TCP acknowledgment is received.

According to one embodiment, the TCP protocol is modified to provide fault tolerant data communication that ensures application-to-application delivery of data. Such embodiments are transparent to surrounding routers that implement standard TCP. Thus, no modifications are required to existing routers to interoperate with routers implementing the fault tolerant TCP protocol.

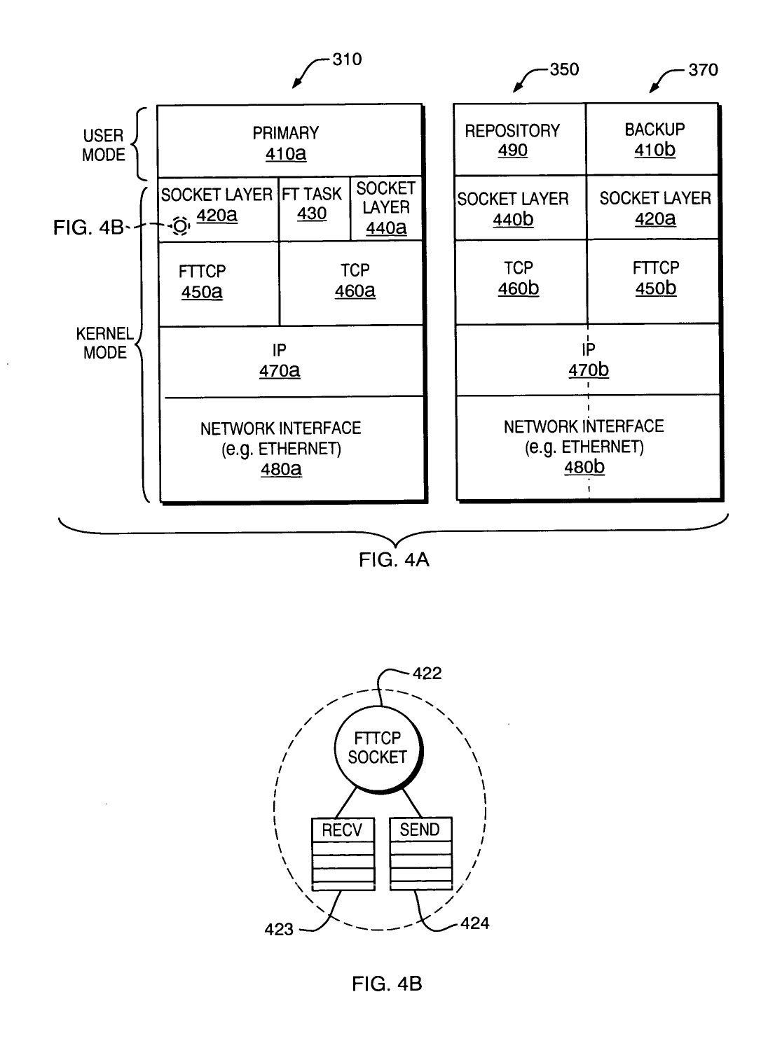

FIG. 4 is a diagram illustrating the software components that implement fault tolerant TCP connections with remote peers according to one embodiment. Fault tolerant TCP (FTTCP) may be implemented in the primary and backup server modules 220a, 220b with (i) TCP-compatible FTTCP protocol drivers 450a, 450b; (ii) FTTCP Socket Layer Interfaces 420a, 420b; (iii) an FTTCP Task 430; and (iv) a repository process 490. TCP protocol drivers 460a, 460b and TCP Socket Layer Interfaces 440a, 440b may also be used for transport to and from the repository process 490. Application processes 410a, 410b interface with FTTCP for reliable exchanges of routing table updates with upstream and downstream routers. IP protocol drivers 470a, 470b and network interface drivers 480a, 480b support the above transport and application layers.

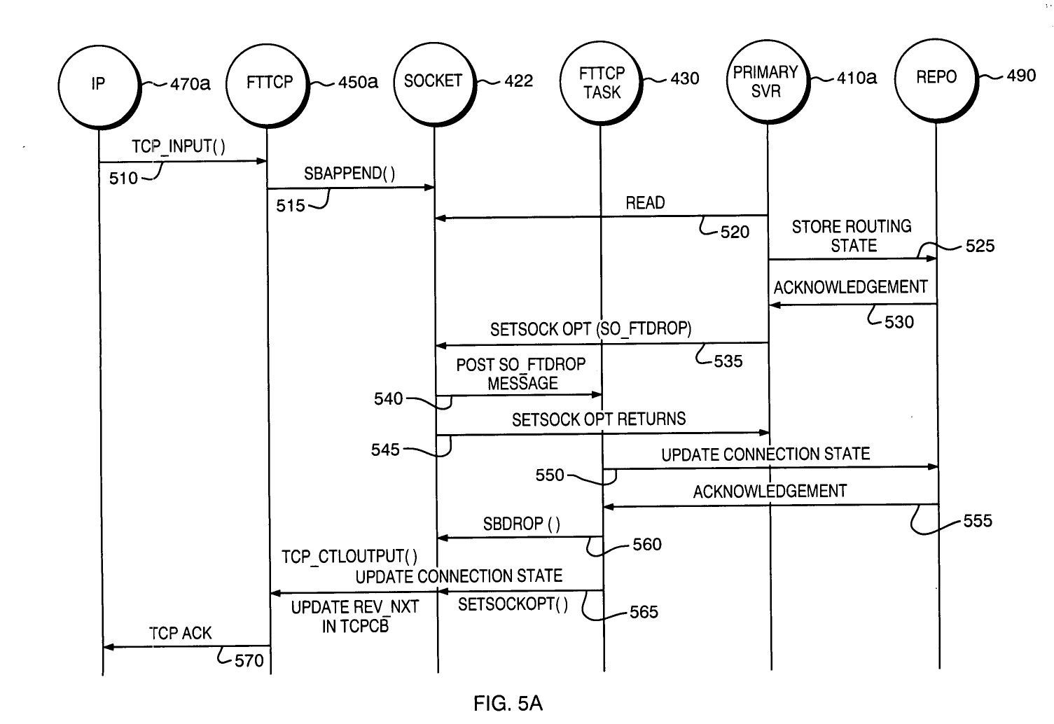

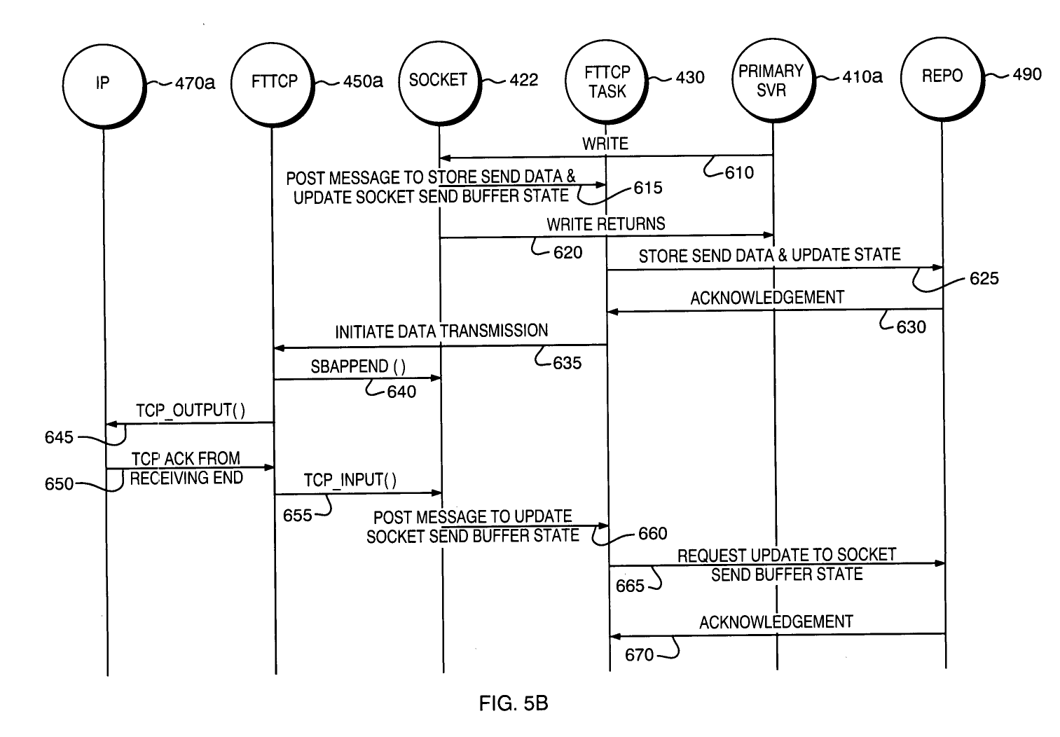

According to one embodiment, the FTTCP protocol driver 450a, 450b is a modified version of TCP, providing fault tolerance by modifying the internal semantics of reading and writing data over a network connections with remote TCP peers, as illustrated in FIGS. 5A and 5B. Application processes, such as primary/backup server processes 410a, 410b request network services (e.g., read and write services) from the FTTCP protocol driver 450a, 450b through the socket layer interface 420a, 420b modified for FTTCP. According to one embodiment, the FTTCP socket layer interface 420a, 420b provides an API (Application Program Interface) of socket system calls, similar to the TCP socket layer interface 440a, 440b for the standard TCP protocol driver 460a, 460b. A FTTCP socket 422 represents the endpoint of a transport layer connection and is a special type of file handle used by an application process to request network services from the kernel. The FTTCP socket 422 is associated with a receive buffer 423 and a send buffer 424 for temporary storage of TCP segments in transit.

The FTTCP Task 430 may be a kernel process communicating over TCP/IP with the repository process 490, transmitting the connection states of FTTCP connections from the FTTCP protocol driver 450a. The repository process 490 may be an user mode process executing on the backup server module 220b. The repository process 490 provides an API interface for maintaining the current state of a routing table as well as the connection states of established FTTCP connections. The repository process 490 also provides an API interface for regenerating the state of the routing table and network connections from the stored states. According to one embodiment, the repository process 490 implements an associative array or hash table for state storage.

Embodiments of FTTCP implement modifications to the read and write semantics of TCP in order to ensure synchronization of both ends of an FTTCP connection in the event of a server failure. For instance, TCP normally sends an acknowledgment of a TCP segment upon receipt. However, after transmitting the ACK, the application process may fail before reading and processing the data, (e.g., routing table update). Thus, when the backup application process becomes instantiated, the routing table regenerated from the repository may not contain the routing table update. Retransmission is also unlikely, if the TCP segment containing the update was previously acknowledged.

FIG. 5A is a state diagram illustrating read processing over a fault tolerant TCP connection according to one embodiment. In general, FTTCP does not acknowledge receipt of TCP segments until explicitly directed to do so. According to one embodiment, the application process directs FTTCP to transmit an ACK after the data has been processed and successfully secured in the repository. If the application process fails before securing the data to the repository, an acknowledgment is not transmitted. Thus, the remote TCP peer may continue to retransmit the data, allowing transition to a backup application process for processing and acknowledging the retransmitted data. Although FTTCP may be utilized in a variety of applications, FIG. 5A illustrates read processing over fault tolerant TCP connections in a router environment.

At 510, a TCP/IP packet transmitted over an FTTCP connection is received by the IP protocol driver 470a. The TCP segment, containing at least a portion of the routing table update, is extracted from the packet and forwarded to the FTTCP protocol driver 450a via a modified tcp_input system call.

At 515, the FTTCP protocol driver 450a appends the data from the TCP segment to a socket receive buffer 423 of FTTCP socket 422, which is associated with the destination TCP port identified in the TCP segment header. For BGP, the well-known TCP port identifier is 179. Contrary to TCP, the modified tcp_input system call of the FTTCP protocol driver 450a neither acknowledges receipt of the TCP packet nor updates the connection state (e.g., incrementing the receive next sequence number) at this stage.

At 520, an application process 410a (e.g., GateD™ primary server process from NextHop Technologies™) reads the data from the socket receive buffer 423 by invoking a read system call. Contrary to TCP, data is not immediately “dropped” (i.e., removed) from the socket receive buffer 423 after being read. To drop the data in the socket receive buffer 423, the primary server process must issue an explicit request to the FTTCP socket 422 in the socket layer 420a.

At 525, the primary server process 410a processes the data read from the socket receive buffer 423 by incorporating the routing table update into the BGP routing table and storing the processed routing update in the repository 490. According to one embodiment, the primary server process transmits the processed routing table update to the repository 490 via TCP/IP layers 460a, 470a.

At 530, an acknowledgment message back from the repository process 490 confirms storage of the processed routing table update.

At 535, upon consuming the data, the primary server process 410a directs the socket 422 to drop the data from the socket receive buffer 423. According to one embodiment, the primary server process 410a directs the socket 422 to drop the data by invoking a modified setsockopt( ) system call with a new socket level option, SO_FTDROP, and the number of bytes to be dropped.

At 540, the modified setsockopt( ) system call processes the SO_FTDROP option, posting a message to a queue associated with FTTCP Task 430. The SO_FTDROP message requests the Task 430 to update the connection state of the FTTCP connection in the repository 490. According to one embodiment, the connection state includes a receive next sequence number, representing the current receive state of the FTTCP connection.

At 545, the setsockopt( ) system call returns to the primary server process 410a, allowing further application level processing.

At 550, the FTTCP Task 430 sends the updated connection state via a TCP/IP connection to the repository 490 for storage and then waits for an acknowledgment indicating whether the update was successfully committed to the repository 490.

At 555, an acknowledgment is received from the repository process 490.

At 560, upon a successful acknowledgment, the FTTCP Task 430 directs the removal of the data read from the socket receive buffer 423. According to one embodiment, the data is removed from the receive buffer 423 via the standard sbdrop( ) system call, specifying the address of the socket receive buffer 423 and the number of bytes to be dropped.

At 565, the FTTCP Task 430 directs the FTTCP protocol driver 450a to update the connection state of the FTTCP connection (i.e., the receive next sequence number for the FTTCP connection). According to one embodiment, the FTTCP Task 430 directs the update of the receive next sequence number by invoking the modified setsockopt( ) system call identifying FTTCP as the a new protocol level and specifying a new option TCP_FT_DROP. This option is filtered down into the FTTCP protocol driver 450a where it is handled by the tcp_ctloutput( ) system call, updating the receive next sequence number for the FTTCP connection.

At 570, upon updating the receive next sequence number, the FTTCP protocol driver 450a sends a TCP segment to the remote peer of the FTTCP connection acknowledging the previously received TCP segment and identifying the sequence number of the next TCP segment expected to be received.

By committing the receive next sequence number to the repository prior to acknowledging the TCP segment, the local receive window will always be equal or ahead of the peer's send window. In the event of a failure, the repository either has the same information as the TCP peer or more recent information than the client. The more recent information is reflected in TCP by the receive window being ahead of the peer's send window.

FIG. 5B is a state diagram illustrating write processing over a fault tolerant TCP connection according to one embodiment. In general, FTTCP supports “atomic” writes. Thus, when an application process issues a system call to write data over a FTTCP connection, FTTCP attempts to commit an entire copy of the data for transmission (i.e. send data) to the repository. If there is insufficient space to store the entire send data, the write system call returns with an error. Otherwise, the data is committed to the repository and FTTCP may transmit the data according to standard TCP processes. If the application process fails during a transmission of send data, a copy of the send data is available in the repository for retransmission by a backup application process. To avoid retransmitting the entire send data on a transition to the backup application process, any portion of send data that is acknowledged by a remote peer is removed from the repository with the corresponding connection state of the FTTCP connection updated. FIG. 5B illustrates write processing over FTTCP connections in a router environment.

At 610, the primary server process 410a invokes a write system call to initiate transmission of the send data over an FTTCP connection. Before writing the send data to the socket send buffer 424 of FTTCP socket 422, the write system call determines whether there is sufficient space in the socket send buffer 424 to hold the entire content. According to one embodiment, the socket send buffer 424 space is redefined to be equal to the size of the send data plus the current size of the data waiting in the send buffer 424 queue. If there is not enough space, the write system call returns with an error. Otherwise, the write processing proceeds to 615.

At 615, a message is posted to the FTTCP Task 430, requesting storage of the send data in the repository 490 and updating the state of the socket send buffer 424 in the repository. According to one embodiment, the state of the socket send buffer 424 includes the send next sequence number and the send unacknowledged sequence number.

At 620, the write system call returns to the primary server process, allowing further application level processing.

At 625, the FTTCP Task 430 sends the data and state of the socket send buffer 424 to the repository 490 via a TCP/IP connection and then waits for an acknowledgment from the repository, indicating whether the data was successfully committed to the repository 490.

At 630, the repository sends an acknowledgment to the FTTCP Task 430.

At 635, upon receiving a successful acknowledgment, the FTTCP Task 430 makes a request to the FTTCP protocol driver 450a to initiate the transmission of the data over the FTTCP connection. According to one embodiment, the system call is tcp_usrreq(PRU_SEND).

At 640, in response to transmission request, the FTTCP protocol driver 450a transfers the data from the write buffer, which is passed in with the write system call, to the socket send buffer 424 via the sbappend( ) system call.

At 645, the process of generating TCP segments and transmitting them over the FTTCP connection is initiated via the tcp_output system call. In particular, the FTTCP protocol driver 450a divides the content of the message into data fragments, which are added to the payload of multiple TCP/IP data packets. Each TCP segment transmitted includes a send sequence number, as defined by the TCP protocol.

At 650, the receiving end acknowledges receipt of a TCP segment identifying the next sequence number that it is expecting to receive next.

At 655, the FTTCP protocol driver 450a forwards the TCP segment containing the ACK to a socket receive buffer 423 of FTTCP socket 422 in the socket layer 420a.

At 660, the FTTCP socket 422 directs the FTTCP Task 430 to update the state of the socket send buffer 424 in the repository 490 by updating the send next sequence number and the send unacknowledged sequence number, effectively deleting the acknowledged portion of the send data stored in the repository 490.

At 665, the FTTCP Task 430 transmits the updated state of the socket send buffer 424 and waits for an acknowledgment message from the repository 490.

At 670, the repository 490 sends an acknowledgment message, indicating whether the storage request was successful.

Steps 645 to 670 repeat until the entire send data is transmitted and acknowledged by the receiving end of the FTTCP connection.

In the case where the primary server process 410a fails, the repository 490 maintains an entire copy of the message that maybe retransmitted less any data previously acknowledged. Even if the primary server process 410a fails prior to receipt of a TCP ACK from the receiving end, it is acceptable to retransmit BGP data, which was previously received and acknowledged. In particular, the BGP protocol accepts content from packets not previously received, but discards those already received.

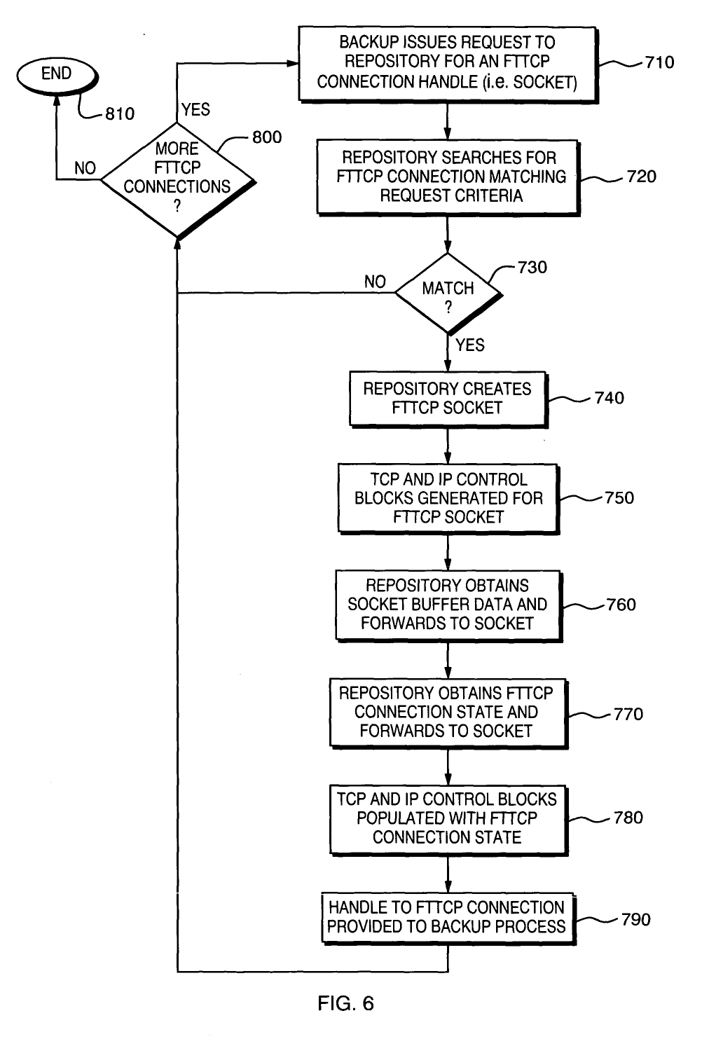

FIG. 6 is a flow diagram illustrating a process for re-establishing the FTTCP connections during backup mode of data communication from a primary application process to a backup application process according to one embodiment. Upon being activated in the backup server module 220b, the backup server process 410b, such as the GateD™ backup server process, communicates with the repository process 490 to reestablish the local side of all FTTCP connections that were in progress at the time the primary server process 410a failed. Once the connection are reestablished, the backup server process 410b may continue exchanging data avoiding data loss.

Recreating an FTTCP connection means that the TCP control block (TCPCB) and internet control block (INPCB) must retain to the same state they were in before the crash. All the pertinent information to create these data structures is stored in the connection information in the repository. The kernel takes the connection struct and repopulates the tcpcb and inpcb. The socket send buffer 424 can easily be recreated by appending the send buffer 424 in the repository into the newly created sockets and buffer. FIG. 6 illustrated re-establishing FTTCP connections in a router environment.

At 710, the GateD™ backup process 410b issues a request to the repository process 490 for a handle (e.g., socket identifier) to an FTTCP connection. According to one embodiment, the Backup server process 410b is preconfigured with a list of foreign address/port pairs identifying routers with whom to exchange routing information. Thus, the Backup server process 410b iterates through the list requesting FTTCP connection, identifying the foreign address/port pair as the request criteria.

At 720, the repository process 490 searches its internal data stores, such as a hash table or associative array, for an FTTCP connection data structure matching the request criteria. If, at 730, a match is found, the process proceeds to 740. Otherwise, the repository process 490 returns with an error, allowing the Backup server process 410b to make requests for other FTTCP connections.

At 740, the repository process 490 creates an FTTCP socket by issuing a system call through the socket layer 420b. For example, the system call may be expressed as

so=socket(AF_{—}INET, SOCK_{—}STREAM, IPPROTO_{—}FTTCP)

where so is the returned FTTCP socket identifier.

At 750, in response to the request for an FTTCP socket, TCP and IP control blocks (i.e., tcpcb and inpcb) are generated for the socket.

At 760, the repository 490 obtains all socket send buffer 424 data for the FTTCP connection and forwards it to the socket via the socket layer 420b, where it is appended to the socket send buffer 424 of the FTTCP socket. For example, the system call may be expressed as:

setsockopt(so, SOL_{—}SOCKET, SO_{—}FTCONNDATA, buffer, size)

where the socket send buffer data is stored in buffer.

At 770, the repository 490 obtains the connection state for the FTTCP connection and forwards it to the socket. For example, the system call may be expressed as:

setsockopt(so, SOL_{—}SOCKET, SO_{—}FTCONNSTATE, &connd, sizeof (rep_{—}connection_{—}t))

where connd holds the FTTCP connection state data structure (i.e., struct rep_connection_t). According to one embodiment, the FTTCP connection state data structure may store the following:

(i) the connection type, whether connected or accepted;

(ii) a unique FTTCP connection identifier provided by the repository for indexing;

(iii) a connection tuple representing the FTTCP socket (e.g., local and foreign address/port pairs);

(iv) the TCP state, as defined by the TCP protocol;

(v) receive next and send next sequence numbers;

(vi) a send unacknowledged sequence number;

(vii) a send maximum window sequence number; and

(viii) initial send and receive sequence numbers.

At 780, the TCP and IP control blocks are populated with the FTTCP connection state and then adds the IP control block to the inpcb hash table to enable the connection on the local side.

At 790, the repository returns a handle (i.e., socket identifier) to the Backup server process 410b to continue exchanging routing table updates over the FTTCP socket connection.

At 800, the Backup server process 410b iterates through the list of preconfigured FTTCP connection tuples, forwarding other requests until the list is exhausted.

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of fault tolerant data communication, comprising:
engaging in a communication, including transfer of data and communication state with a source;
receiving data from the source;
processing the received data; and
acknowledging receipt of the data back to the source thereafter.

2. The method of claim 1, wherein processing the received data includes storing or
applying the received data to one or more data stores for backup purposes.

3. The method of claim 2, further comprises:
storing a communication state in the one or more data stores, such that the communication state is associated with the data stored or applied to the one or more data stores.

4. The method of claim 3, further comprising:
activating a backup upon a failure;
regenerating data and communication state from the data and communication state in the one or more data stores; and
continuing the communication restored with the regenerated data and communication state by the backup.

5. The method of claim 4, wherein continuing the communication by the backup comprises:
expecting to receive data from the source that corresponds to the communication state stored in one or more data stores prior to the failure.

6. The method of claim 3, wherein the communication state is derived from a previous communication state and the received data.

7. The method of claim 3, wherein the communication state comprises TCP session data.

8. The method of claim 1, wherein the communication is a TCP/IP communication.

9. The method of claim 1, wherein the received data is routing information.

10. The method of claim 9, wherein the routing information is BGP (Border Gateway Protocol) routing information.

11. The method of claim 1, where the source is an Internet router.

12. A method of fault tolerant data communication, comprising:
engaging in a communication, including transfer of data and communication state, with a source;
receiving data from the source;
storing or applying the received data to one or more data stores for backup purposes; and
storing a communication state in the one or more data stores, such that the communication state is associated with the data stored or applied to the one or more data stores.

13. The method of claim 12, further comprising:
activating a backup upon a failure;
regenerating data and communication state from the data and communication state in the one or more data stores; and
continuing the communication generated with the requested data and communication state by the backup.

14. The method of claim 13, wherein continuing the communication by the backup comprises:
expecting to receive data from the source that corresponds to the communication state stored in one or more data stores prior to the failure.

15. A method of fault tolerant data communication comprising:
engaging in a communication, including transfer of data and communication state, with a destination;
storing send data for transfer to the destination in one or more data stores; and
storing a communication state in one or more data stores, such that the communication state is associated with the send data.

16. The method of claim 15, further comprising:
transmitting the send data in fragments to the destination; and
updating the communication state in the one or more data stores, such that communication state reflects the transmitted fragments.

17. The method of claim 16, further comprising:
receiving acknowledgments corresponding to the transmitted fragments; and
updating the communication state in the one or more data store to reflect the acknowledgment of the transmitted fragments.

18. The method claim 17, further comprising:
deleting portions of the send data in the one or more data stores that correspond to acknowledged transmitted fragments.

19. A system of fault tolerant data communication, comprising:
a control unit engaging in a communication, including transfer of data and communication state with a source;
the control unit receiving data from the source;
the control unit processing the received data; and
the control unit acknowledging receipt of the data back to the source thereafter.

20. The system of claim 19, further comprising:
one or more data stores; and
the processing of the received data comprising the control unit storing or applying the received data to one or more data stores for backup purposes.

21. The system of claim 20, further comprising:
the control unit storing a communication state in the one or more data stores, such that the communication state is associated with the data stored or applied to the one or more data stores.

22. The system of claim 21, further comprising:
a backup control unit being activated upon a failure of the control unit;
the backup control unit regenerating data and communication state from the data and communication state in the one or more data stores; and
the backup control unit continuing the communication restored with the regenerated data and communication state.

23. The system of claim 22, wherein continuing the communication by the backup comprises:
the backup control unit expecting to receive data from the source that corresponds to the communication state stored in one or more data stores prior to the failure.

24. The system of claim 21, wherein the communication state is derived from a previous communication state and the received data.

25. The system of claim 21, wherein the communication state comprises TCP session data.

26. The system of claim 19, wherein the communication is a TCP/IP communication.

27. The system of claim 19, wherein the received data is routing information.

28. The system of claim 27, wherein the routing information is BGP (Border Gateway Protocol) routing information.

29. The system of claim 19, where the source is an Internet router.

30. A system of fault tolerant data communication, comprising:
a control unit engaging in a communication, including transfer of data and communication state, with a source;
the control unit receiving data from the source;
the control unit storing or applying the received data to one or more data stores for backup purposes; and
the control unit storing a communication state in the one or more data stores, such that the communication state is associated with the data stored or applied to the one or more data stores.

31. The system of claim 30, further comprising:
a backup control unit being activated upon a failure of the control unit;
the backup control unit regenerating data and communication state from the data and communication state in the one or more data stores; and
the backup control unit continuing the communication generated with the requested data and communication state.

32. The system of claim 31, wherein continuing the communication by the backup control unit comprises:
the backup control unit expecting to receive data from the source that corresponds to the communication state stored in one or more data stores prior to the failure.

33. A system of fault tolerant data communication comprising:
a control unit engaging in a communication, including transfer of data and communication state, with a destination;
the control unit storing send data for transfer to the destination in one or more data stores; and
the control unit storing a communication state in one or more data stores, such that the communication state is associated with the send data.

34. The system of claim 33, further comprising:
the control unit transmitting the send data in fragments to the destination; and
the control unit updating the communication state in the one or more data stores, such that communication state reflects the transmitted fragments.

35. The system of claim 34, further comprising:
the control unit receiving acknowledgments corresponding to the transmitted fragments; and
the control unit updating the communication state in the one or more data store to reflect the acknowledgments of the transmitted fragments.

36. The system of claim 35, further comprising:
the control unit deleting portions of the send data in the one or more data stores that correspond to acknowledged transmitted fragments.

37. The system of claim 19, wherein the control unit comprises:
an application process;
a connection-oriented transport protocol process;
the application process engaging in the communication with the source via the transport protocol process; and
the transport protocol process acknowledging receipt of the data back to the source after being processing by the application process.

38. The system of claim 37, wherein the transport protocol process stores a communication state in one or more data stores, such that the communication state is associated with the received data stored or applied to the one or more data stores.

39. The system of claim 33, wherein the control unit comprises:
an application process;
a connection-oriented transport protocol process;
the application process engaging in the communication while the destination via the transport protocol process;
the transport protocol process storing send data from the application process for transfer to the destination in the one or more data store; and
the transport protocol process storing the communication state in the one or more data stores, such that the communication state is associated with the send data.

40. An internet router comprising:
a control unit electrically coupled to one or more external links, the control unit engaging in a communication, including transfer of data and communication state, with the remote router via one of the external links;
the control unit receiving routing data from the remote router;
the control unit processing the received routing data; and
the control unit acknowledging receipt of the data back to the remote router thereafter.

41. The internet router of claim 40, wherein processing the received routing data includes the control unit storing or applying the received routing data to one or more data stores for backup purposes.

42. The internet router of claim 41, further comprising:
the control unit storing a communication state in the one or more data stores, such that the communication state is associated with the routing data stored or applied to the one or more data stores.

43. The internet router of claim 42, further comprising:
a backup control unit being activated upon a failure of the control unit;
the backup control unit regenerating data and communication state from the data and communication state in the one or more data stores; and
the backup control unit continuing the communication restored with the regenerated data and communication state.

44. An internet router, comprising:
a control unit engaging in a communication, including transfer of data and communication state, with a remote router;
the control unit receiving routing data from the remote router;
the control unit storing or applying the routing data to one or more data stores for backup purposes; and
the control unit storing a communication state in the one ore more data stores, such that the communication state is associated with the routing data stored or applied to the one or more data stores.

45. An internet router, comprising:
a control unit engaging in a communication, including transfer of data and communication state, with a remote router;
the control unit storing send data for transfer to the remote router in one or more data stores; and
the control unit storing a communication state in one or more data stores, such that the communication state is associated with the send data.

46. The internet router of claim 45, further comprising:
the control unit transmitting the send data in fragments to the destination; and
the control unit updating the communication state in the one or more data stores, such that communication state reflects the transmitted fragments.

47. The internet router of claim 46, further comprising:
the control unit receiving acknowledgments corresponding to the transmitted fragments; and
the control unit updating the communication state in the one or more data store to reflect the acknowledgments of the transmitted fragments.

48. The internet router of claim 47, further comprising:
the control unit deleting portions of the send data in the one or more data stores that correspond to acknowledged transmitted fragments.
